(19) United States
(12) Patent Application Publication
(10) Pub. No.: US 2026/0118205 A1
(43) Pub. Date: Apr. 30, 2026

(54) DETECTING AND LOCATING HIGH-PRESSURE GAS LEAKS USING OPEN-AIR SOUND

(71) Applicants: International Business Machines Corporation, Armonk, NY (US); ExxonMobil Technology and Engineering Company, Spring, TX (US)

(72) Inventors: Bruce Gordon Elmegreen, Goldens Bridge, NY (US); William Trojak, London (GB); Eloisa Bentivegna, Warrington (GB); Levente Klein, Tuckahoe, NY (US); Anantha Sundaram, Annandale, NJ (US); Arash Fathi, Morris Plains, NJ (US); Grant Jay Seastream, Jersey City, NJ (US)

(21) Appl. No.: 18/912,095

(22) Filed: Oct. 10, 2024

(51) Int. Cl. G01M 3/24

(52) U.S. Cl. CPC G01M 3/24

(57) ABSTRACT

A system includes a processor that executes computer executable components stored in a memory and a set of at least two disparate sound detection devices that receive sound waves at at least two receiving locations. The computer executable components include a determination component that determines amplitude, phase, and frequency of the respective received sound waves by the sound detection devices. The computer executable components include an analysis component that determines a phase difference between and a frequency spectrum of the received sound waves to determine a location of a potential a gas leak. The computer executable components include an identification component that identifies a location of a potential gas leak.

### TECHNICAL FIELD

The subject disclosure relates to gas leak detection, e.g., systems and methods for detecting and locating high-pressure gas leaks using open-air sound.

### BACKGROUND

Combustible gases of various types have been delivered in pipelines to towns, houses, and industries for over 200 years. With the recent development of high-pressure pipes to move natural gas (e.g., methane) from underground mining sites to users on a continental scale, there is growing concern about leaks into the atmosphere.

Methane is a potent greenhouse gas. It can escape pipeline infrastructure in small amounts through normal operation of pumps, valves and storage tanks at extraction sites, but more significant are unplanned emissions, especially from super-emitters that can release more than 100 kg of methane per hour. These super-emitters are often in remote areas, and they can leak for many days before discovered.

Satellite detection is possible for largest leaks, but a typical methane detection satellite may fly over each region only once per week, and, even then, the emission may be too dispersed by winds or too obscured by clouds to detect via satellite. Methane is also emitted more slowly by natural sources, including agriculture, livestock, wetlands, and thawing artic tundra. These emissions are problematic because they add to the methane background, thereby making pipeline leak detection by remote imagery more ambiguous.

Other gases are likely to be transmitted via high-pressure pipeline movement as well, including hydrogen for fuel and carbon dioxide for underground sequestration or enhanced oil recovery. Hydrogen could be particularly difficult to detect because of its small molecular size and low molecular weight, which make it more diffusive than methane. Hydrogen, like methane, is also highly flammable, and thus the detection of hydrogen leaks is important for public safety. Carbon dioxide is non-flammable and odorless, but toxic to humans when its fraction in the air exceeds 5%.

### SUMMARY

The following presents a summary to provide a basic understanding of some embodiments of the invention. This summary is not intended to identify key or critical elements or delineate any scope of the particular embodiments or any scope of the claims. Its sole purpose is to present concepts in a simplified form as a prelude to the more detailed description that is presented later. In some embodiments described herein, systems, computer-implemented methods, and/or computer program products that facilitate detecting and locating high-pressure gas leaks using open-air sound are provided.

According to an embodiment, a system can comprise a processor that executes computer executable components stored in memory. The computer executable components can comprise a first sound detection device and a second sound detection device that receives sound waves at different receiving locations. The computer executable components comprise a determination component that determines amplitude, phase, and frequency of the respective received sound waves received by the set of at least two sound detection devices at the at least two receiving locations. The computer executable components can further comprise an analysis component that determines a phase difference between, and a frequency spectrum of the respective sound waves received at the at least two locations to determine a location of a potential a gas leak. The computer executable components can further comprise an identification component that identifies a location of a potential gas leak.

According to another embodiment, a method for detecting gas leaks based on sound detection and localization can comprise utilizing a set of at least two sound detection devices located in different locations to receive sound waves. The method can further comprise detecting amplitude and phase of the received sound waves, measuring phase difference between the received sound waves, and utilizing a phase analyzer to determine a location of a potential gas leak.

According to another embodiment, a system for detecting gas leaks based on sound detection and localization can comprise a memory that stores computer executable components; a processor that executes the computer executable components stored in the memory; a set of at least two disparate sound detection devices that receive sound waves at at least two receiving locations; a determination component that determines amplitude, phase, and frequency of the respective received sound waves by the set of at least two sound detection devices at the at least two receiving locations; an analysis component that determines a phase difference between and a frequency spectrum of the respective sound waves received at the at least two locations to determine a location of a potential a gas leak; and an identification component that identifies location of a potential gas leak.

### DESCRIPTION OF THE DRAWINGS

FIG. 1 illustrates block diagram of an example system that can facilitate detecting and locating high-pressure gas leaks using open-air sound in accordance with one or more embodiments described herein.

FIG. 2 illustrates block diagram of an example system that can facilitate detecting and locating high-pressure gas leaks using open-air sound in accordance with one or more embodiments described herein.

FIG. 3 illustrates a flow diagram of an example computer implemented method that facilitates detecting and locating high-pressure gas leaks using open-air sound in accordance with one or more embodiments described herein.

FIG. 4 illustrates a flow diagram of an example computer implemented method that facilitates detecting and locating high-pressure gas leaks using open-air sound in accordance with one or more embodiments described herein.

FIG. 5 illustrates an example diagram of two sound detection devices, operably connected to a common local processing system, detecting the same sound at slightly different phases.

FIG. 6 illustrates an example diagram of two independent sound detection devices, located at different locations, detecting sound frequency of the same sound at different phases. It will be appreciated that the sound detection devices are capable of detecting directionality based at least upon phase differences and sound frequency.

FIG. 7 illustrates an example diagram of how a direction of a source of a sound may be calculated from the phase difference in the sound signal received by paired sound detection devices.

FIG. 8 illustrates an example diagram, of how a location of a source of a sound may be calculated by triangulating calculated directions and distances from several pairs of sound detection devices.

FIG. 9 illustrates an example schematic frequency spectrum of how received sound changes with distance from the omission source in a predictable manner due to atmospheric absorption.

FIG. 10 illustrates an example schematic frequency spectrum detected at three distances from a source.

FIG. 11 illustrates a block diagram of an example computing environment in which one or more embodiments described herein can be facilitated.

### DETAILED DESCRIPTION

The following detailed description is merely illustrative and is not intended to limit embodiments and/or application or uses of embodiments. Furthermore, there is no intention to be bound by any expressed or implied information presented in the preceding Background or Summary sections, or in the Detailed Description section.

According to an embodiment, a system can comprise a memory that stores computer executable components. The system can further comprise a processor that executes the computer executable components stored in the memory to perform operations. The operations can comprise receiving sound waves by two or more sound detection devices. The operations can further comprise detecting amplitude, phase, and frequency of the respective sound waves at the two or more sound detection devices. The operations can further comprise determining phase difference between the respective sound waves and determining a frequency spectrum of the received sound waves. The operations can further comprise determining, as a function of the phase difference and frequency spectrum, a location of a potential gas leak.

In some embodiments of the aforementioned system, determining the location can further comprise determining a direction of and distance to the potential gas leak from at least one of the sound detection devices.

In some embodiments, determining the location further comprises determining a direction of and distance to the potential gas leak from at least one of the microphones. The determining of the location may be based at least in part on a possible position in common from a range of frequencies received by the sound detection devices.

In some embodiments, the operations may further comprise comparing the detected amplitude and phase of the respective sound waves to measurements of actual gas leaks.

The operations may further comprise training an artificial intelligence model to detect source and character of high-pressure gas leaks from sound leaks received by the two or more sound detection devices.

In some embodiments of the same system, the operations further comprise determining direction and distance of the potential gas leak with respect to each sound detection device, and identifying a possible source at least in part by comparing the determined directions and distances. The location of the potential gas leak may be determined by deriving a single position in common at an intersection of the determined directions and distances of the sound detection devices.

In some embodiments, the sound detection devices are microphones. It is to be appreciated that any suitable wave or frequency detection device or system can be employed in connection with embodiments described herein.

In some embodiments, operations comprise measuring a sound intensity of the respective sound waves with a sampling rate at least as high as twice the highest detected frequency.

According to an embodiment, a system can comprise a memory that stores computer executable components. The system can further comprise a processor that executes the computer executable components stored in the memory to perform operations. The operations can comprise receiving sound waves by two or more sound detection devices and detecting amplitude, phase and frequency of the respective sound waves at the two or more sound detection devices. The operations can further comprise determining a time interval between the phase detected by the two or more sound devices and, as a function of the determined time interval and frequency, determining a location of a potential gas leak.

Combustible gases of various types have been delivered in pipelines to towns, houses, and industries for over 200 years. With the recent development of high-pressure pipes to move natural gas (e.g., methane) from underground mining sites to users on a continental scale, there is growing concern about leaks into the atmosphere.

Methane is a potent greenhouse gas. It can escape pipeline infrastructure in small amounts through normal operation of pumps, valves and storage tanks at extraction sites, but more significant are unplanned emissions, especially from super-emitters that can release more than 100 kg of methane per hour. These super-emitters are often in remote areas, and they can leak for many days before discovered.

Satellite detection is possible for largest leaks, but a typical methane detection satellite may fly over each region only once per week, and, even then, the emission may be too dispersed by winds or too obscured by clouds to detect via satellite. Methane is also emitted more slowly by natural sources, including agriculture, livestock, wetlands, and thawing artic tundra, and these can be a problem too because they add to the methane background of several parts per million, and this background makes pipeline leak detection by remote imagery more ambiguous.

Other gases are likely to be transmitted via high-pressure pipeline movement as well, including hydrogen for fuel and carbon dioxide for underground sequestration or enhanced oil recovery. Hydrogen could be particularly difficult to detect because of its small molecular size and low molecular weight, which make it more diffusive than methane. Hydrogen, like methane, is also highly flammable, and thus the detection of hydrogen leaks is important for public safety. Carbon dioxide is non-flammable and odorless, but it is toxic to humans when its fraction in the air exceeds 5%, making proximity to a major carbon dioxide leak a concerning safety hazard.

Embodiments disclosed herein pertain to detection of large gas leaks by sounds they emit in free air. Methane is at high pressure inside pipelines, often exceeding 5 to 10 atmospheres in distribution systems and up to 70 atm in long pipelines. As a result, the gas initially emitted from a pipeline break moves close to the speed of sound, producing a jet of methane and entrained atmospheric gas over a distance that can span many meters from the initial opening site. Hydrogen pipelines can be at 100 atmospheres pressure. Similarly, carbon dioxide is highly pressurized in pipelines, typically exceeding 70 atmospheres at room temperature to turn it into a liquid-like supercritical fluid for underground storage or use. High-speed emission from high-pressure leaks produces noise with a broad frequency spectrum that is loud enough to hear with conventional sound equipment for several kilometers.

In view of the problems discussed above, in relation to undetected gas leaks, embodiments can be implemented to produce a solution to one or more of these problems by utilizing a set of at least two sound detection devices located in different locations to receive sound waves. In some embodiments, the solution includes detecting amplitude, phase, and frequency of the received sound waves. In some embodiments, the solution includes measuring phase difference between the received sound waves or a time interval between two measured phases for a known source frequency. In some embodiments, the solution includes utilizing a phase analyzer to determine a location of a potential gas leak, and thereby determine an at least one potential gas leak location.

Embodiment(s) relate to the placement of sound detectors (e.g., microphones), which may be omnidirectional, in a plurality of locations covering likely emission sites, and to process phase and amplitude of received sound as a function of frequency and time. The sound detectors can have muffling protection to minimize wind noise. Electronic processing for adjacent pair of detectors may be used to determine time difference between an arrival of each phase of a sound vibration. Cross correlation of signals with phase delays may be used to determine this phase difference. From the phase difference, direction to a source may be determined to within a plurality of angles from a bisector line between detectors. Other sound detector pairs and other frequencies may define different sets of possible directions. A possible source location may be at one of the intersection points of detector pairs.

The frequency of distribution of a detected sound may be compared with predicted or measured frequency spectrum of a typical source modified by muffling protection. Because rate of absorption of sound in air is proportional to square of frequency, high frequency parts of sound are absorbed by air closest to a source, thereby distorting a spectrum with diminishing high frequency signal as distance from source increases. In this way, a distance to source may be determined.

Where there are only two pairs of broad-band sound detectors, both direction and distance to source may be determined first using a phase difference for each frequency and detector pair, and distance may then be confirmed or determined from a plurality of possible distances using an atmospheric distortion of frequency spectrum compared to a model source spectrum.

One or more embodiments are now described with reference to the drawings, where like referenced numerals are used to refer to like elements throughout. In the following description, for purposes of explanation, numerous specific details are set forth in order to provide a more thorough understanding of one or more embodiments. It is evident, however, in various cases, that one or more embodiments can be practiced without these specific details.

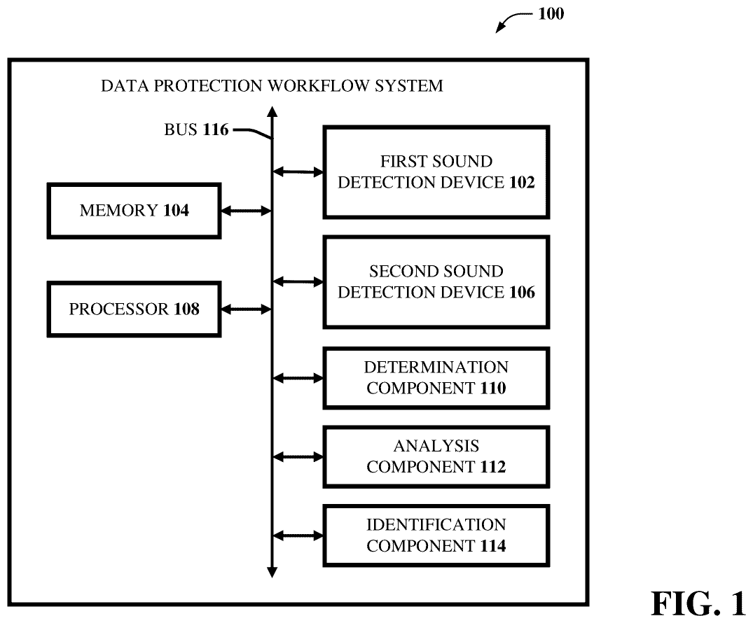

FIG. 1 illustrates an example system 100 for facilitating detection of large gas leaks by sound they emit in free air. The system 100 uses a first sound detection device 102 and a second sound detection device 106 that receive sound waves at different receiving locations. The system 100 can also include a determination component 110 that determines amplitude, phase, and frequency of respective received sound waves. The system 100 can include an analysis component 112 that determines phase difference between the respective sound waves received at the at least two locations to determine location of a potential a gas leak. The system 100 can include an identification component 114 that identifies a location of a potential gas leak.

Aspects of systems (e.g., systems 100, 200, and the like), apparatuses or processes in various embodiments of the present invention can constitute one or more machine-executable components embodied within one or more machines (e.g., embodied in one or more computer readable mediums (or media) associated with one or more machines). Such components, when executed by one or more machines, e.g., computers, computing devices, virtual machines, etc. can cause the machines to perform the operations described. System 100 can comprise first sound detection component 102, memory 104, second sound detection component 106, processor 108, determination component 110, analysis component 112, identification component 114, and system bus 116.

The system 100 and/or the components of the system 100 may use hardware and/or software to solve problems that are highly technical in nature. The system 100 solves problems that are not abstract and that cannot be performed as a set of mental acts by a human. Further, some of the processes may be performed by specialized computers for carrying out defined tasks related to recovery plan development. The system 100 and/or components of the system 100 may be employed to solve new problems that arise through advancements in technologies. The system 100 may provide technical improvements to gas leak detection by reducing time and effort requirements in detecting gas leaks.

The system 100 may include a processor 108. In some embodiments, the processor 108 may execute a component or subcomponent associated with the system 100. Components or subcomponents associated with the system 100 may include one or more machine readable, writable, and/or executable instructions. In some embodiments, the system 100 may include a memory 104, and the memory 104 may store one or more components and/or subcomponents associated with the system 100. In some embodiments, the processor 108 may execute a component stored in the memory 104.

In some embodiments, the system 100 may include a computer-readable memory 104 that may be operably connected to the processor 108. The memory 104 may store computer-executable instructions that, upon execution by the processor 108, may cause the processor 108 and/or one or more other components of the system 100 (e.g., the application identification component 102, the analysis component 116, and/or the recovery design component 110) to perform one or more actions. In some embodiments, the memory 104 may store computer-executable components (e.g., the application identification component 102, the analysis component 116, and/or the recovery design component 110).

The system 100 and/or a component thereof as described herein may be communicatively, electrically, operatively, optically, and/or otherwise coupled to one another via a bus 112. The bus 112 may include one or more of a memory bus, memory controller, peripheral bus, external bus, local bus, and/or another type of bus that may employ one or more bus architectures. In some embodiments, the system 100 may be coupled (e.g., communicatively, electrically, operatively, optically, and/or the like) to one or more external systems (e.g., an electrical output production system, one or more output targets, an output target controller, and/or the like). In some embodiments, the system 100 may be coupled to one or more external sources, and/or devices (e.g., classical computing devices, communication devices, and/or like devices), such as via a network. In some embodiments, one or more of the components of the system 100 may reside in the cloud and/or locally in a local computing environment (e.g., at one or more specified locations).

In addition to the processor 108 and/or the memory 104 described above, the system 100 may include one or more computer and/or machine readable, writable, and/or executable components and/or instructions. When executed by the processor 108, these components and/or instructions may enable performance of one or more operations defined by the component(s) and/or instruction(s).

In various embodiments, the first sound detection component 102 and second sound detection component 106 receive sound waves at at least two receiving locations. In some embodiments, the first sound detection component 102 and second sound detection component 106 are microphones. Determination component 110 may also determine an amplitude and phase of the respective sound waves received by the sound detection devices at the at least two receiving locations. Analysis component 112 can determine a phase difference between the respective sound waves received at the at least two locations to determine a location of a potential gas leak. Analysis component 112 may also determine frequency distribution of detected sounds and compare the frequency distributions with predicted or measured frequency spectrums. According to some embodiments, identification component 114 identifies a location of a potential gas leak.

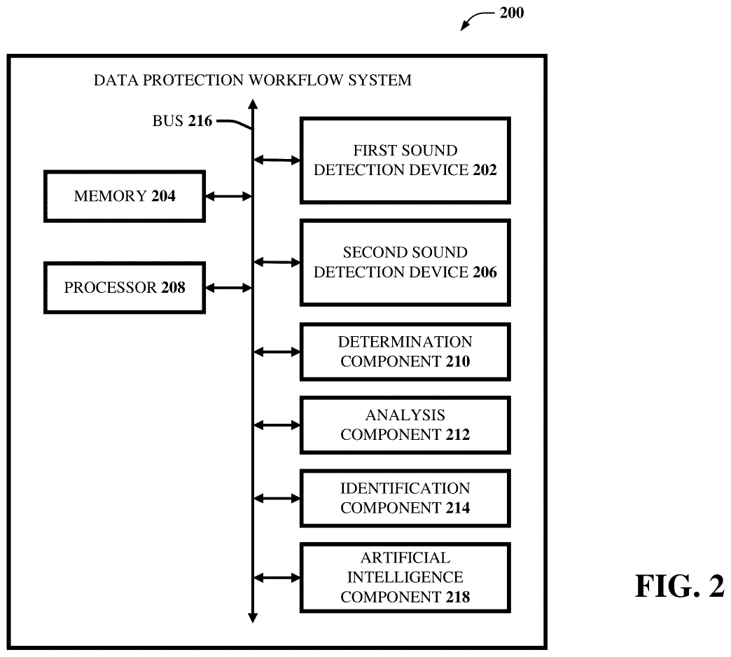

FIG. 2 illustrates an example system 200 for facilitating detection of large gas leaks by sound they emit in free air. The system 200 uses a first sound detection device 202 and a second sound detection device 206 that receive sound waves at different receiving locations. The system 200 can also include determination component 210 that determines amplitude, phase, and frequency of respective received sound waves. The system 200 can include an analysis component 212 that determines a phase difference between the respective sound waves received at the at least two locations to determine a location of a potential a gas leak. The system 200 can include an identification component 214 that identifies a location of a potential gas leak, and an artificial intelligence (AI) component 218 that is trained on signals received by the sound detection devices and the identified location of the potential gas leak.

Aspects of systems (e.g., systems 100, 200, and the like), apparatuses or processes in various embodiments of the present invention can constitute one or more machine-executable components embodied within one or more machines (e.g., embodied in one or more computer readable mediums (or media) associated with one or more machines). Such components, when executed by one or more machines, e.g., computers, computing devices, virtual machines, etc. can cause the machines to perform the operations described. System 200 can comprise first sound detection component 202, memory 204, second sound detection component 206, processor 208, determination component 210, analysis component 212, and identification component 214, system bus 116, and artificial intelligence component 218.

Discussion of like components has been omitted for sake of brevity.

In various embodiments, artificial intelligence component 218 can be trained on signals received by the sound detection devices and the identified location of the potential gas leak. Embodiments can utilize artificial intelligence and deep learning. Machine learning is a subset of artificial intelligence that focuses on the development of algorithms and statistical models that enable computers to learn and make predictions or decisions based on data without being explicitly programmed to do so. In essence, machine learning algorithms learn from patterns and relationships within the data to improve performance over time. For embodiments described herein there are many options such as DNN (Deep neural networks). Deep neural networks (DNNs) are a class of artificial neural networks that are specifically designed to handle complex and high-dimensional data. They are a form of machine learning algorithms that have significantly advanced the field of artificial intelligence (AI) in recent years.

Machine learning can be broadly categorized into three main types based on the learning approach used: supervised learning, unsupervised learning, and reinforcement learning. These three types of machine learning represent different approaches to learning from data and solving various types of problems. Many real-world applications may involve a combination of these approaches or use techniques from one type to complement those of another.

In supervised learning, the algorithm is trained on a labeled dataset, where each input data point is associated with a corresponding target or label. The goal of supervised learning is to learn mapping from input features to output labels, based on the patterns and relationships present in the labeled training data. Supervised learning tasks include classification, where the goal is to predict a categorical label for each input data point, and regression, where the goal is to predict a continuous value for each input data point. Common algorithms used in supervised learning include linear regression, logistic regression, decision trees, random forests, support vector machines (SVM), and neural networks.

In unsupervised learning, the algorithm is trained on an unlabeled dataset, where no explicit labels or targets are provided. The goal of unsupervised learning is to discover patterns, relationships, and structure within the data without the guidance of labeled examples. Unsupervised learning tasks include clustering, where the goal is to partition the data into groups or clusters based on similarity, and dimensionality reduction, where the goal is to reduce the number of features in the data while preserving important information. Common algorithms used in unsupervised learning include k-means clustering, hierarchical clustering, principal component analysis (PCA), and autoencoders.

In reinforcement learning, the algorithm learns through interaction with an environment by taking actions and receiving feedback in the form of rewards or penalties. The goal of reinforcement learning is to learn a policy or strategy that maximizes cumulative rewards over time by exploring different actions and learning from their outcomes. Reinforcement learning tasks include learning to play games, robotic control, autonomous driving, and optimizing business processes. Common algorithms used in reinforcement learning include Q-learning, deep Q-networks (DQN), policy gradient methods, and actor-critic methods. For this innovation, reinforcement learning to train the model for self-correction can be considered.

The choice of machine learning model depends on various factors, including the nature of the data, the task at hand, computational resources, and interpretability requirements. However, some machine learning models are commonly used across different applications due to their versatility and effectiveness. Examples of commonly used machine learning models include linear regression, logistic regression, decision trees, random forests, support vector machines, K-nearest neighbors, and neural networks.

Linear regression is a simple, yet powerful model used for predicting a continuous target variable based on one or more input features. It assumes a linear relationship between the input features and the target variable and seeks to find the best-fitting line or hyperplane that minimizes the difference between the predicted and actual values.

Logistic regression is a binary classification model used for predicting the probability that an input belongs to a particular class. It models the relationship between the input features and the binary outcome using the logistic function, which maps the input values to probabilities between 0 and 1.

Decision trees are versatile models used for both classification and regression tasks. They partition the feature space into a series of hierarchical decisions based on the values of input features, ultimately leading to a prediction at the leaf nodes of the tree.

Random forests are an ensemble learning method that combines multiple decision trees to improve predictive performance and reduce overfitting. They build multiple decision trees on bootstrapped samples of the training data and aggregate their predictions to make more robust predictions.

Support vector machines are powerful models used for classification and regression tasks. They find the optimal hyperplane that separates the data into different classes or predicts continuous values, while maximizing the margin between the classes.

K-nearest neighbors is a simple and intuitive model used for classification and regression tasks. It makes predictions by finding the majority class or averaging the values of the k nearest data points in the feature space.

Neural networks are highly flexible models inspired by the structure and function of the human brain. They consist of interconnected layers of neurons that learn complex patterns and relationships in the data through a process called backpropagation.

The AI component 218 can train and generate models to facilitate taking automated action, e.g., source of leak detection, notification to technicians, provide recommended courses of action in connection with embodiments described herein. For example, the AI component 218 can monitor signals from respective sensors, and based on an inference or determination, with high confidence score that a gas leak is likely, the AI component can notify field technicians, provide location, even launch a drone to rapidly surveil the likely leak source location and transmit live video/audio to relevant parties.

In some embodiments, the artificial intelligence component 218 is trained on signals received by the set of at least two disparate sound detection devices and the identified location of the potential gas leak. The location of a potential gas leak may be identified at least in part based upon spectral and temporal characteristics of received sound waves. The at least two sound detection devices may be microphones. According to some embodiments, the analysis component also determines frequency distribution of detected sounds and compares the frequency distributions with predicted or measured frequency spectrums.

Advantages of this system include reduced cost, power, and data requirements in identifying potential gas leaks and near-instantaneous identification and notification of a leak via the rapid propagation of sound waves from the leak.

The systems and/or devices have been (and/or will be further) described herein with respect to interaction between one or more components. Such systems and/or components can include those components or sub-components specified therein, one or more of the specified components and/or sub-components, and/or additional components. Sub-components can be implemented as components communicatively coupled to other components rather than included within parent components. One or more components and/or sub-components can be combined into a single component providing aggregate functionality. The components can interact with one or more other components not specifically described herein for the sake of brevity, but known by those of skill in the art.

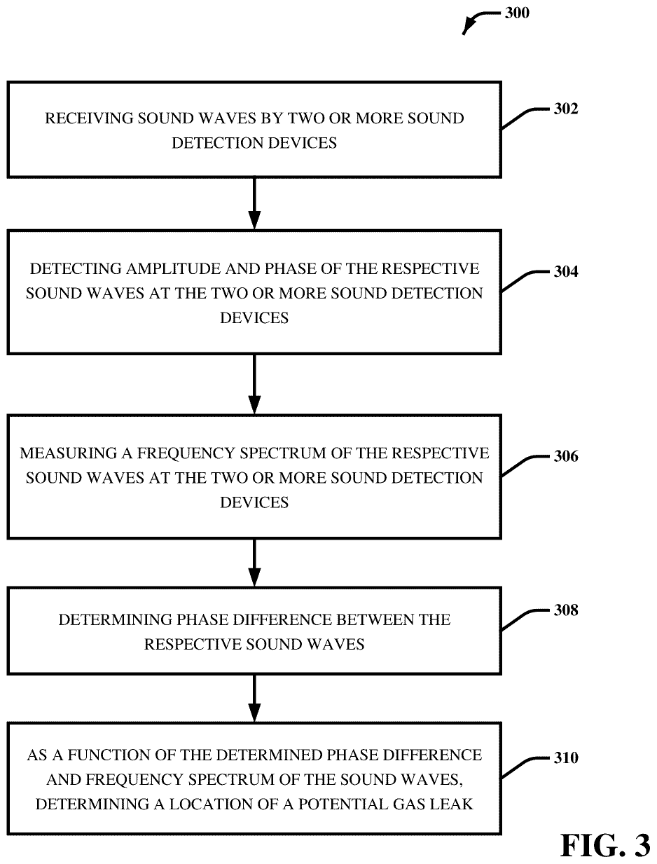

FIG. 3 illustrates an example gas leak identification flow diagram 300 that can facilitate detecting and locating high-pressure gas leaks using open-air sound.

At 302, sound waves are received by two or more sound detection devices.

At 304, amplitude and phase of the respective sound waves at the two or more sound detection devices are detected.

At 306, a frequency spectrum of the respective sound waves at the two or more sound detection devices is measured.

At 308, phase difference between the respective sound waves is determined.

At 310, as a function of the determined phase difference and measured frequency spectrum of the sound waves, a location of a potential gas leak is determined.

While the method 300 is described relative to the system 200 of FIG. 2, the method 300 can be applicable also to other systems described herein, such as the system 100 of FIG. 1. Repetitive description of like elements and/or processes employed in respective embodiments is omitted for sake of brevity.

According to an embodiment, determining the location further comprises determining a direction of and a distance to the potential gas leak from at least one of the sound detection devices. In some embodiments, the distance is determined at least in part based on the determined phase difference. The location determination can be based at least in part on possible position in common from a range of frequencies.

In some embodiments, the detected amplitude and phase of the respective sound waves can be compared to measurements of actual gas leaks.

In some embodiments, an artificial intelligence model is trained to detect source and character of high-pressure gas leaks from sound leaks received by the two or more sound detection devices.

In some embodiments, the direction of and distance to the potential gas leak may be determined with respect to each sound detection device, and a possible gas leak source may be identified at least in part by comparing the determined directions and distances. In some embodiments, the location of the potential gas leak can be determined by deriving a single position in common at an intersection of the determined directions and distances of the sound detection devices.

According to an embodiment, the sound detection devices are microphones.

In some embodiments, a sound intensity of the respective sound waves is measured with a sampling rate at least as high as twice the highest detected frequency, e.g., utilizing Nyquist theorem.

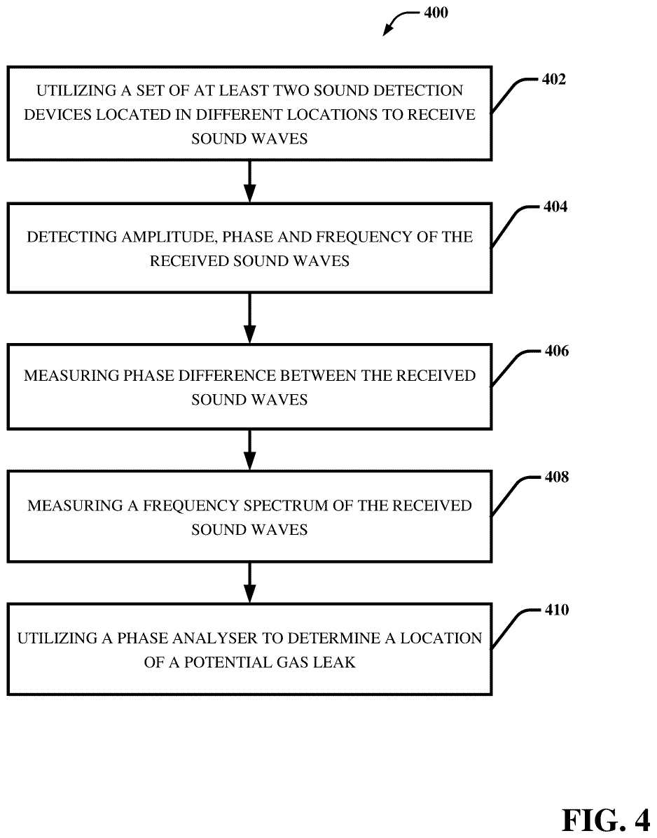

FIG. 4 illustrates an example gas leak identification flow diagram 300 that can facilitate detecting and locating high-pressure gas leaks using open-air sound, in accordance with one or more embodiments described herein, such as the system 200 of FIG. 2. While the method 400 is described relative to the system 200 of FIG. 2, the method 400 can be applicable also to other systems described herein, such as the system 100 of FIG. 1. Repetitive description of like elements and/or processes employed in respective embodiments is omitted for sake of brevity.

At 402, the method includes utilizing a set of at least two sound detection devices located in distinct locations to receive sound waves.

At 404, the method includes detecting amplitude and phase of the received sound waves.

At 406, the method includes measuring phase difference between the received sound waves.

At 408, the method includes measuring a frequency spectrum of the received sound waves.

At 410, the method includes utilizing a phase analyzer to determine a location of a potential gas leak.

According to an embodiment, the phase analyzer further determines respective frequency distributions of detected sounds. The phase analyzer can further compare the determined frequency distributions with predicted or measured frequency spectrums. A notification regarding location of the potential gas leak may be transmitted by the system. An artificial intelligence model can be trained on signals received from the sound detection devices and the determined location of the potential gas leak by the system.

For simplicity of explanation, the computer-implemented methods provided herein are depicted and/or described as a series of actions. It is to be understood that the subject matter is not limited by the actions illustrated and/or by the order thereof. For example, actions can occur in one or more orders, concurrently, and/or with other acts not presented and described herein. Furthermore, not all illustrated actions can be utilized to implement the computer-implemented methods in accordance with the described subject matter. In addition, the computer-implemented methods could alternatively be represented as a series of interrelated states via a state diagram or events. Additionally, the computer-implemented methods described in this specification are capable of being stored on an article of manufacture to facilitate transporting and transferring the computer-implemented methods to computers. The term article of manufacture, as used herein, encompasses a computer program accessible from any computer-readable device or storage media.

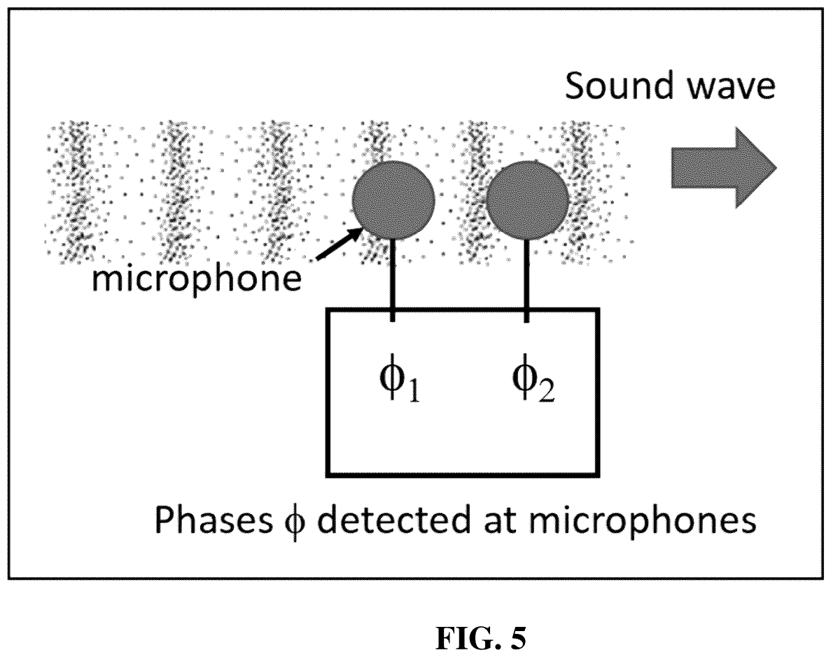

FIG. 5 illustrates an example diagram of two sound detection devices, operably connected to a common local processing system, detecting the same sound at slightly different phases. It will be appreciated that the phases will be transmitted more quickly to one of the sound detection devices as compared to the other. Thus, a single pair of sound detection devices are capable of detecting directionality from the time interval between the peak phase or other particular phase detected by the detectors and from the frequency of the sound, in the same way that a pair of human ears are similarly capable of detecting directionality. It will be appreciated that frequency may be determined by either detector alone, or by both detectors together.

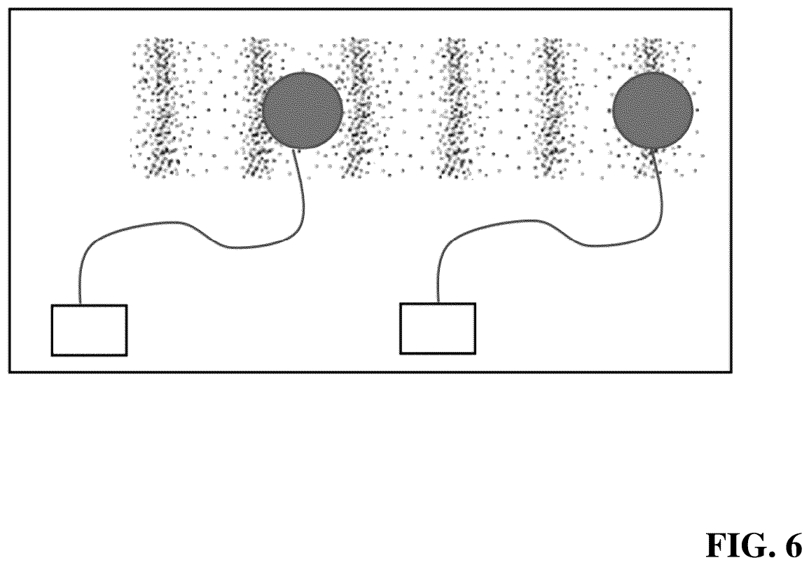

FIG. 6 illustrates an example diagram of two independent sound detection devices, located at different locations, detecting sound frequency of the same sound at different phases. It will be appreciated that the sound detection devices are capable of detecting directionality based at least upon phase differences and sound frequency.

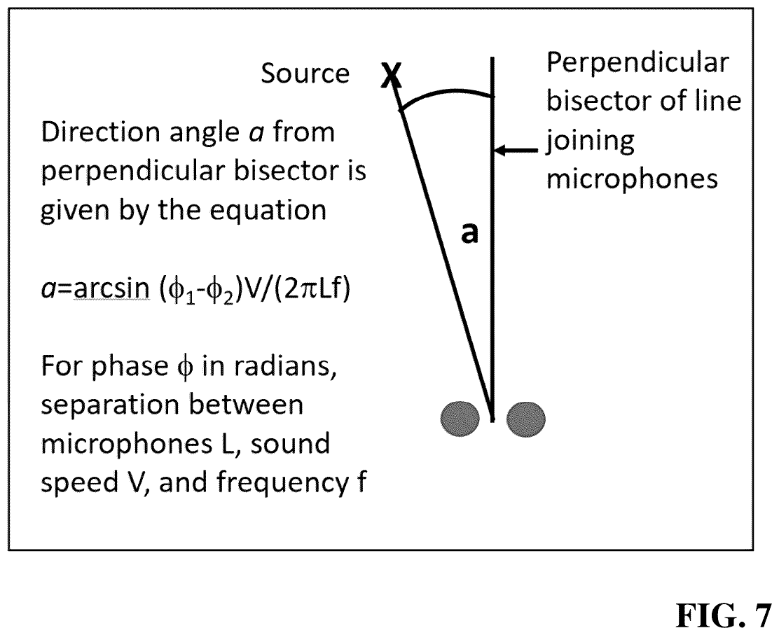

FIG. 7 illustrates an example diagram of how a direction of a source of a sound may be calculated from the phase difference in the sound signal received by paired sound detection devices. It will be appreciated that frequency or time interval between certain phases detected by the sound devices may be used to calculate the quantity “(phi1-phi2)V/L” in FIG. 7, which occurs in the argument of arcsin function. “V” represents the speed of sound and “L” the separation between sound detection devices. In the denominator of that argument is a frequency “f.” The quantity “(phi1-phi2)V/L” is the inverse of the time between phases phi1 and phi1. A time interval between same-phases may be determined from a cross correlation of signals from the sound detection devices, both at the same frequency. The cross correlation is the product between the two signals with some time delay imposed in the product. When the time delay imposed in the product equals the real time delay, then the product will be a maximum. Thus, the sum of S(t)*S(t-delta) would be evaluated for a certain period, such as 10 seconds, wherein “S” is the signal which is a function of time (t) and delta is a small interval of time, so S(t-delta) is the signal at a time previous to the current time (t) by the small amount delta. This summed product may be evaluated for a range in delta. For the delta where the summed product is a maximum, that delta is the time difference for each particular phase to move from one sound detection device to the other. The inverse of that (measured time interval) is (phi1-phi2)V/L. So sound speed does not need to be measured, just the time interval of the phase. Frequency “f” may be necessary to get the direction to the source. The source frequency may be determined by the phase rate detected by each sound detection device, separately. Standard sound electronics may easily determine the frequency. For a range in frequencies (which is generally the case for a source) it is helpful to determine a time interval for the phase propagation from one sound detection device to the other [(phi1-phi2)V/L) at a particular frequency, which is the frequency in the denominator of the argument of arcsin.

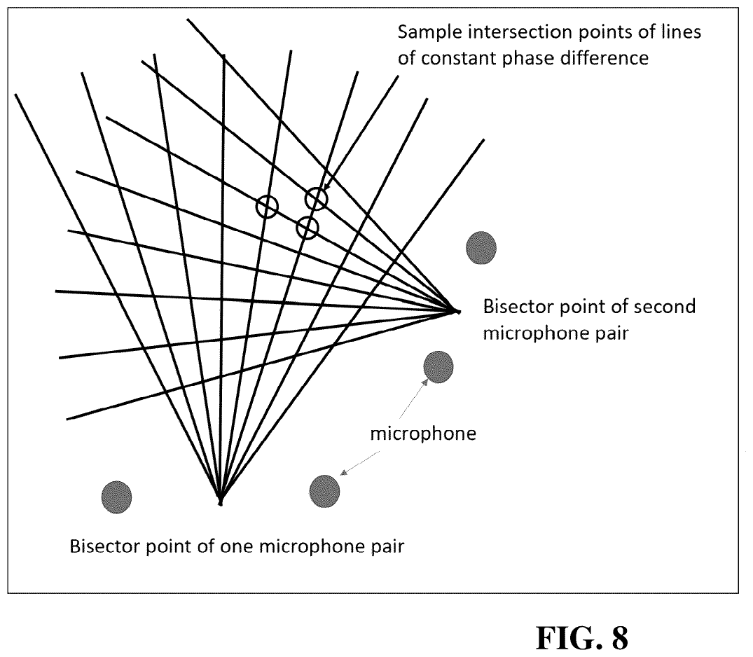

FIG. 8 illustrates an example diagram, of how a location of a source of a sound may be calculated by triangulating calculated directions and distances from several pairs of sound detection devices. Here, the spectral signature can be used to calculate the distance to a source of a sound. Additionally, because the high frequency of the sound is absorbed faster through air, examination of where cutoff occurs in frequency enables a determination of the source location of the sound.

It will be appreciated that the sound detection devices may be calibrated in various ways, and not just those illustrated herein. For example, sound detection devices may be manually calibrated by emitting a sound from a known source/location, such as the clapping of hands. Alternatively, the sound detection devices may be self-calibrating. For example, the sound detection devices may calibrate automatically by communicating with adjacent sound detection devices or nearby sound detection devices, or via a GPS system. It should be appreciated that the sound detection devices are capable of being calibrated in numerous alternative ways beyond those disclosed herein; examples recounted herein are not intended to be limiting in any way.

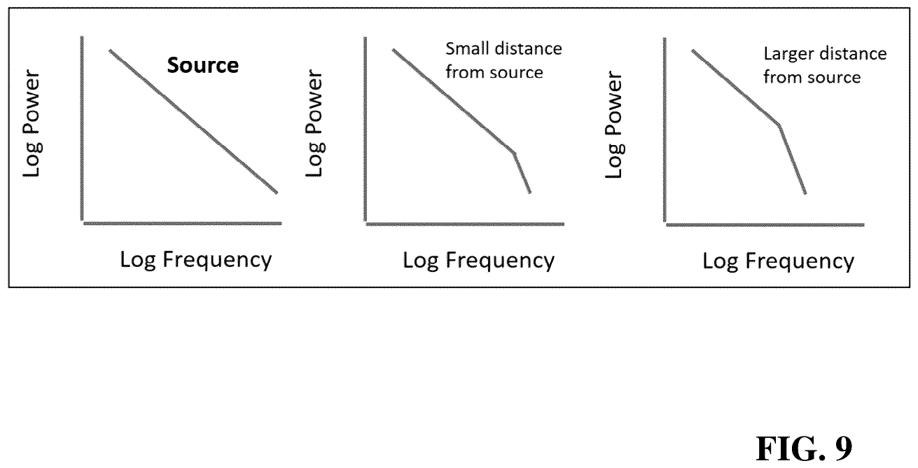

FIG. 9 illustrates an example schematic frequency spectrum of how received sound changes with distance from the omission source in a predictable manner due to atmospheric absorption. Because absorption is greater at higher frequencies, the high-frequency part of the spectrum drops out after the sound travels through the air, with the drop out getting stronger and to a lower frequency as the sound moves further. It will be appreciated that a distance to a source location may be determined from the precise bend point, or drop out point, as observable in the schematic.

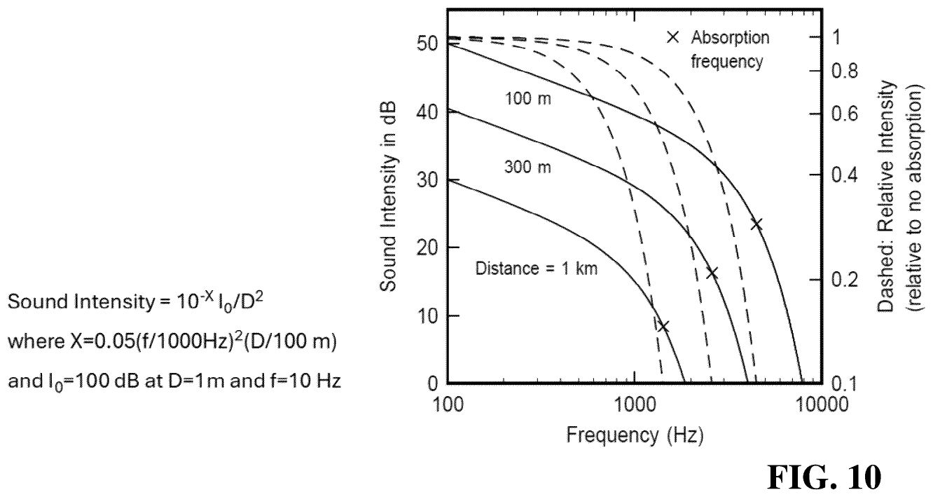

FIG. 10 illustrates an example schematic frequency spectrum detected at three distances from a source with a power spectrum of 1/f, and with an absorption rate proportional to f². Absorption in air is greater at higher frequencies, making the detected spectrum drop significantly below the distance-diminished source spectrum, which would otherwise continue to decrease with increased frequency approximately as a straight line in the example schematic frequency spectrum FIG. 10. The crosses in FIG. 10 mark the characteristics frequencies where the detected signal is 10 decibels lower than which it would be without absorption in the intervening air. These characteristic frequencies, obtained from each sound detection device signal, may be used to determine the distance between the sound detection device and the source of the sound.

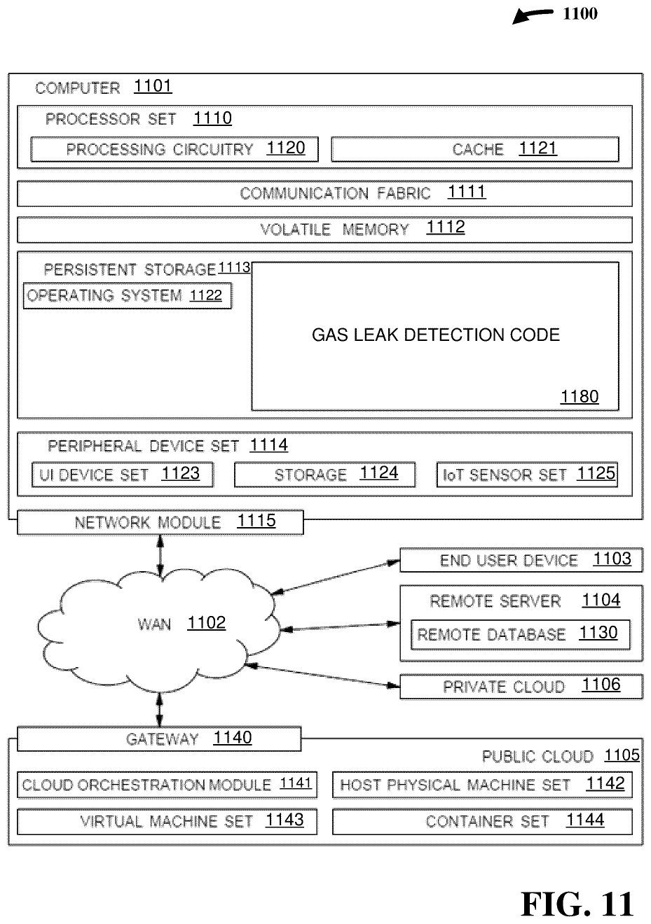

FIG. 11 and the following discussion are intended to provide a brief, general description of a suitable computing environment 1100 in which some embodiments described herein can be implemented. For example, various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks can be performed in reverse order, as a single integrated step, concurrently or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium can be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include diskette, hard disk, random access memory (RAM), read-only memory (ROM), erasable programmable read-only memory (EPROM or Flash memory), static random-access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

Computing environment 1100 contains an example of an environment for the execution of at least some of the computer code involved in performing the inventive methods, such as iteratively updating the preliminary recovery plan until a failure-free recovery plan is developed with gas leak detection code 1180. In addition to block 1180, computing environment 1100 includes, for example, computer 1101, wide area network (WAN) 1102, end user device (EUD) 1103, remote server 1104, public cloud 1105, and private cloud 1106. In this embodiment, computer 1101 includes processor set 1114 (including processing circuitry 1120 and cache 1121), communication fabric 1111, volatile memory 1112, persistent storage 1113 (including operating system 1122 and block 1145, as identified above), peripheral device set 1114 (including user interface (UI), device set 1123, storage 1124, and Internet of Things (IoT) sensor set 1125), and network module 1115. Remote server 1104 includes remote database 1130. Public cloud 1105 includes gateway 1140, cloud orchestration module 1141, host physical machine set 1142, virtual machine set 1143, and container set 1144.

COMPUTER 1101 can take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 1130. As is well understood in the art of computer technology, and depending upon the technology, performance of a computer-implemented method can be distributed among multiple computers and/or between multiple locations. On the other hand, in this presentation of computing environment 1100, detailed discussion is focused on a single computer, specifically computer 1101, to keep the presentation as simple as possible. Computer 1101 can be located in a cloud, even though it is not shown in a cloud in FIG. 11. On the other hand, computer 1101 is not required to be in a cloud except to any extent as can be affirmatively indicated.

PROCESSOR SET 1110 includes one, or more, computer processors of any type now known or to be developed in the future. Processing circuitry 1120 can be distributed over multiple packages, for example, multiple, coordinated integrated circuit chips. Processing circuitry 1120 can implement multiple processor threads and/or multiple processor cores. Cache 1121 is memory that is located in the processor chip package(s) and is typically used for data or code that should be available for rapid access by the threads or cores running on processor set 1110. Cache memories are typically organized into multiple levels depending upon relative proximity to the processing circuitry. Alternatively, some, or all, of the cache for the processor set can be located “off chip.” In some computing environments, processor set 1110 can be designed for working with qubits and performing quantum computing.

Computer readable program instructions are typically loaded onto computer 1101 to cause a series of operational steps to be performed by processor set 1110 of computer 1101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 1121 and the other storage media discussed below. The program instructions, and associated data, are accessed by processor set 1110 to control and direct performance of the inventive methods. In computing environment 1100, at least some of the instructions for performing the inventive methods can be stored in block 1145 in persistent storage 1113.

COMMUNICATION FABRIC 1111 is the signal conduction path that allows the various components of computer 1101 to communicate with each other. Typically, this fabric is made of switches and electrically conductive paths, such as the switches and electrically conductive paths that make up busses, bridges, physical input/output ports and the like. Other types of signal communication paths can be used, such as fiber optic communication paths and/or wireless communication paths.

VOLATILE MEMORY 1112 is any type of volatile memory now known or to be developed in the future. Examples include dynamic type random access memory (RAM) or static type RAM. Typically, the volatile memory is characterized by random access, but this is not required unless affirmatively indicated. In computer 1101, the volatile memory 1112 is located in a single package and is internal to computer 1101, but, alternatively or additionally, the volatile memory can be distributed over multiple packages and/or located externally with respect to computer 1101.

PERSISTENT STORAGE 1113 is any form of non-volatile storage for computers that is now known or to be developed in the future. The non-volatility of this storage means that the stored data is maintained regardless of whether power is being supplied to computer 1101 and/or directly to persistent storage 1113. Persistent storage 1113 can be a read only memory (ROM), but typically at least a portion of the persistent storage allows writing of data, deletion of data and re-writing of data. Some familiar forms of persistent storage include magnetic disks and solid-state storage devices. Operating system 1122 can take several forms, such as various known proprietary operating systems or open-source Portable Operating System Interface type operating systems that employ a kernel. The code included in block 1145 typically includes at least some of the computer code involved in performing the inventive methods.

PERIPHERAL DEVICE SET 1114 includes the set of peripheral devices of computer 1101. Data communication connections between the peripheral devices and the other components of computer 1101 can be implemented in various ways, such as Bluetooth connections, Near-Field Communication (NFC) connections, connections made by cables (such as universal serial bus (USB) type cables), insertion type connections (for example, secure digital (SD) card), connections made though local area communication networks and even connections made through wide area networks such as the internet. In various embodiments, UI device set 1123 can include components such as a display screen, speaker, microphone, wearable devices (such as goggles and smart watches), keyboard, mouse, printer, touchpad, game controllers, and haptic devices. Storage 1124 is external storage, such as an external hard drive, or insertable storage, such as an SD card. Storage 1124 can be persistent and/or volatile. In some embodiments, storage 1124 can take the form of a quantum computing storage device for storing data in the form of qubits. In embodiments where computer 1101 is required to have a large amount of storage (for example, where computer 1101 locally stores and manages a large database) then this storage can be provided by peripheral storage devices designed for storing large amounts of data, such as a storage area network (SAN) that is shared by multiple, geographically distributed computers. IoT sensor set 1125 is made up of sensors that can be used in Internet of Things applications. For example, one sensor can be a thermometer, and another sensor can be a motion detector.

NETWORK MODULE 1115 is the collection of computer software, hardware, and firmware that allows computer 1101 to communicate with other computers through WAN 1102. Network module 1115 can include hardware, such as modems or Wi-Fi signal transceivers, software for packetizing and/or de-packetizing data for communication network transmission, and/or web browser software for communicating data over the internet. In some embodiments, network control functions and network forwarding functions of network module 1115 are performed on the same physical hardware device. In other embodiments (for example, embodiments that utilize software-defined networking (SDN)), the control functions and the forwarding functions of network module 1115 are performed on physically separate devices, such that the control functions manage several different network hardware devices. Computer readable program instructions for performing the inventive methods can typically be downloaded to computer 1101 from an external computer or external storage device through a network adapter card or network interface included in network module 1115.

WAN 1102 is any wide area network (for example, the internet) capable of communicating computer data over non-local distances by any technology for communicating computer data, now known or to be developed in the future. In some embodiments, the WAN can be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 1103 is any computer system that is used and controlled by an end user (for example, a customer of an enterprise that operates computer 1101) and can take any of the forms discussed above in connection with computer 1101. EUD 1103 typically receives helpful and useful data from the operations of computer 1101. For example, in a hypothetical case where computer 1101 is designed to provide a recommendation to an end user, this recommendation would typically be communicated from network module 1115 of computer 1101 through WAN 1102 to EUD 1103. In this way, EUD 1103 can display, or otherwise present, the recommendation to an end user. In some embodiments, EUD 1103 can be a client device, such as thin client, heavy client, mainframe computer and/or desktop computer.

REMOTE SERVER 1104 is any computer system that serves at least some data and/or functionality to computer 1101. Remote server 1104 can be controlled and used by the same entity that operates computer 1101. Remote server 1104 represents the machine(s) that collect and store helpful and useful data for use by other computers, such as computer 1101. For example, in a hypothetical case where computer 1101 is designed and programmed to provide a recommendation based on historical data, then this historical data can be provided to computer 1101 from remote database 1130 of remote server 1104.

PUBLIC CLOUD 1105 is any computer system available for use by multiple entities that provides on-demand availability of computer system resources and/or other computer capabilities, especially data storage (cloud storage) and computing power, without direct active management by the scale. The direct and active management of the computing resources of public cloud 1105 is performed by the computer hardware and/or software of cloud orchestration module 1141. The computing resources provided by public cloud 1105 are typically implemented by virtual computing environments that run on various computers making up the computers of host physical machine set 1142, which is the universe of physical computers in and/or available to public cloud 1105. The virtual computing environments (VCEs) typically take the form of virtual machines from virtual machine set 1143 and/or containers from container set 1144. It is understood that these VCEs can be stored as images and can be transferred among and between the various physical machine hosts, either as images or after instantiation of the VCE. Cloud orchestration module 1141 manages the transfer and storage of images, deploys new instantiations of VCEs and manages active instantiations of VCE deployments. Gateway 1140 is the collection of computer software, hardware and firmware allowing public cloud 1105 to communicate through WAN 1102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 1106 is similar to public cloud 1105, except that the computing resources are only available for use by a single enterprise. While private cloud 1106 is depicted as being in communication with WAN 1102, in other embodiments a private cloud can be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 1175 and private cloud 1176 are both part of a larger hybrid cloud. The embodiments described herein can be directed to one or more of a system, a method, an apparatus and/or a computer program product at any possible technical detail level of integration. The computer program product can include a computer readable storage medium (or media) having computer readable program instructions thereon for causing a processor to carry out aspects of some of the embodiments described herein. The computer readable storage medium can be a tangible device that can retain and store instructions for use by an instruction execution device. The computer readable storage medium can be, for example, but is not limited to, an electronic storage device, a magnetic storage device, an optical storage device, an electromagnetic storage device, a superconducting storage device and/or any suitable combination of the foregoing. A non-exhaustive list of more specific examples of the computer readable storage medium can also include the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon and/or any suitable combination of the foregoing. A computer readable storage medium, as used herein, is not to be construed as being transitory signals per se, such as radio waves and/or other freely propagating electromagnetic waves, electromagnetic waves propagating through a waveguide and/or other transmission media (e.g., light pulses passing through a fiber-optic cable), and/or electrical signals transmitted through a wire.

Computer readable program instructions described herein can be downloaded to respective computing/processing devices from a computer readable storage medium and/or to an external computer or external storage device via a network, for example, the Internet, a local area network, a wide area network and/or a wireless network. The network can comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device. Computer readable program instructions for carrying out operations of some of the embodiments described herein can be assembler instructions, instruction-set-architecture (ISA) instructions, machine instructions, machine dependent instructions, microcode, firmware instructions, state-setting data, configuration data for integrated circuitry, and/or source code and/or object code written in any combination of one or more programming languages, including an object oriented programming language such as Smalltalk, C++ or the like, and/or procedural programming languages, such as the “C” programming language and/or similar programming languages. The computer readable program instructions can execute entirely on a computer, partly on a computer, as a stand-alone software package, partly on a computer and/or partly on a remote computer or entirely on the remote computer and/or server. In the latter scenario, the remote computer can be connected to a computer through any type of network, including a local area network (LAN) and/or a wide area network (WAN), and/or the connection can be made to an external computer (for example, through the Internet using an Internet Service Provider). In some embodiments, electronic circuitry including, for example, programmable logic circuitry, field-programmable gate arrays (FPGA) and/or programmable logic arrays (PLA) can execute the computer readable program instructions by utilizing state information of the computer readable program instructions to personalize the electronic circuitry, in order to perform aspects of some of the embodiments described herein.

Aspects of some of the embodiments described herein are described with reference to flowchart illustrations and/or block diagrams of methods, apparatus (systems), and computer program products according to some embodiments described herein. It will be understood that each block of the flowchart illustrations and/or block diagrams, and combinations of blocks in the flowchart illustrations and/or block diagrams, can be implemented by computer readable program instructions. These computer readable program instructions can be provided to a processor of a general-purpose computer, special purpose computer and/or other programmable data processing apparatus to produce a machine, such that the instructions, which execute via the processor of the computer or other programmable data processing apparatus, can create means for implementing the functions/acts specified in the flowchart and/or block diagram block or blocks. These computer readable program instructions can also be stored in a computer readable storage medium that can direct a computer, a programmable data processing apparatus and/or other devices to function in a particular manner, such that the computer readable storage medium having instructions stored therein can comprise an article of manufacture including instructions which can implement aspects of the function/act specified in the flowchart and/or block diagram block or blocks. The computer readable program instructions can also be loaded onto a computer, other programmable data processing apparatus and/or other device to cause a series of operational acts to be performed on the computer, other programmable apparatus and/or other device to produce a computer implemented process, such that the instructions which execute on the computer, other programmable apparatus and/or other device implement the functions/acts specified in the flowchart and/or block diagram block or blocks.

The flowcharts and block diagrams in the figures illustrate the architecture, functionality and/or operation of possible implementations of systems, computer-implementable methods and/or computer program products according to some embodiments described herein. In this regard, each block in the flowchart or block diagrams can represent a module, segment and/or portion of instructions, which comprises one or more executable instructions for implementing the specified logical function. In one or more alternative implementations, the functions noted in the blocks can occur out of the order noted in the Figures. For example, two blocks shown in succession can be executed substantially concurrently, and/or the blocks can sometimes be executed in the reverse order, depending upon the functionality involved. It will also be noted that each block of the block diagrams and/or flowchart illustration, and/or combinations of blocks in the block diagrams and/or flowchart illustration, can be implemented by special purpose hardware-based systems that can perform the specified functions and/or acts and/or carry out one or more combinations of special purpose hardware and/or computer instructions.

While the subject matter has been described above in the general context of computer-executable instructions of a computer program product that runs on a computer and/or computers, those skilled in the art will recognize that some of the embodiments herein also can be implemented at least partially in parallel with one or more other program modules. Generally, program modules include routines, programs, components and/or data structures that perform particular tasks and/or implement particular abstract data types. Moreover, the described computer-implemented methods can be practiced with other computer system configurations, including single-processor and/or multiprocessor computer systems, mini-computing devices, mainframe computers, as well as computers, hand-held computing devices (e.g., PDA, phone), and/or microprocessor-based or programmable consumer and/or industrial electronics. The illustrated aspects can also be practiced in distributed computing environments in which tasks are performed by remote processing devices that are linked through a communications network. However, one or more, if not all aspects of the embodiments described herein can be practiced on stand-alone computers. In a distributed computing environment, program modules can be located in both local and remote memory storage devices.

As used in this application, the terms “component,” “system,” “platform” and/or “interface” can refer to and/or can include a computer-related entity or an entity related to an operational machine with one or more specific functionalities. The entities described herein can be either hardware, a combination of hardware and software, software, or software in execution. For example, a component can be, but is not limited to being, a process running on a processor, a processor, an object, an executable, a thread of execution, a program and/or a computer. By way of illustration, both an application running on a server and the server can be a component. One or more components can reside within a process and/or thread of execution and a component can be localized on one computer and/or distributed between two or more computers. In another example, respective components can execute from various computer readable media having various data structures stored thereon. The components can communicate via local and/or remote processes such as in accordance with a signal having one or more data packets (e.g., data from one component interacting with another component in a local system, distributed system and/or across a network such as the Internet with other systems via the signal). As another example, a component can be an apparatus with specific functionality provided by mechanical parts operated by electric or electronic circuitry, which is operated by a software and/or firmware application executed by a processor. In such a case, the processor can be internal and/or external to the apparatus and can execute at least a part of the software and/or firmware application. As yet another example, a component can be an apparatus that provides specific functionality through electronic components without mechanical parts, where the electronic components can include a processor and/or other means to execute software and/or firmware that confers at least in part the functionality of the electronic components. In an aspect, a component can emulate an electronic component via a virtual machine, e.g., within a cloud computing system.

In addition, the term “or” is intended to mean an inclusive “or” rather than an exclusive “or.” That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. Moreover, articles “a” and “an” as used in the subject specification and annexed drawings should generally be construed to mean “one or more” unless specified otherwise or clear from context to be directed to a singular form. As used herein, the terms “example” and/or “exemplary” are utilized to mean serving as an example, instance, or illustration. For the avoidance of doubt, the subject matter described herein is not limited by such examples. In addition, any aspect or design described herein as an “example” and/or “exemplary” is not necessarily to be construed as preferred or advantageous over other aspects or designs, nor is it meant to preclude equivalent exemplary structures and techniques known to those of ordinary skill in the art.

As it is employed in the subject specification, the term “processor” can refer to substantially any computing processing unit and/or device comprising, but not limited to, single-core processors; single-processors with software multithread execution capability; multi-core processors; multi-core processors with software multithread execution capability; multi-core processors with hardware multithread technology; parallel platforms; and/or parallel platforms with distributed shared memory. Additionally, a processor can refer to an integrated circuit, an application specific integrated circuit (ASIC), a digital signal processor (DSP), a field programmable gate array (FPGA), a programmable logic controller (PLC), a complex programmable logic device (CPLD), a discrete gate or transistor logic, discrete hardware components, and/or any combination thereof designed to perform the functions described herein. Further, processors can exploit nano-scale architectures such as, but not limited to, molecular and quantum-dot based transistors, switches and/or gates, in order to optimize space usage and/or to enhance performance of related equipment. A processor can be implemented as a combination of computing processing units.

Herein, terms such as “store,” “storage,” “data store,” data storage,” “database,” and substantially any other information storage component relevant to operation and functionality of a component are utilized to refer to “memory components,” entities embodied in a “memory,” or components comprising a memory. Memory and/or memory components described herein can be either volatile memory or nonvolatile memory or can include both volatile and nonvolatile memory. By way of illustration, and not limitation, nonvolatile memory can include read only memory (ROM), programmable ROM (PROM), electrically programmable ROM (EPROM), electrically erasable ROM (EEPROM), flash memory and/or nonvolatile random-access memory (RAM) (e.g., ferroelectric RAM (FeRAM). Volatile memory can include RAM, which can act as external cache memory, for example. By way of illustration and not limitation, RAM can be available in many forms such as synchronous RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), direct Rambus RAM (DRRAM), direct Rambus dynamic RAM (DRDRAM) and/or Rambus dynamic RAM (RDRAM). Additionally, the described memory components of systems and/or computer-implemented methods herein are intended to include, without being limited to including, these and/or any other suitable types of memory.

What has been described above includes mere examples of systems and computer-implemented methods. It is, of course, not possible to describe every conceivable combination of components and/or computer-implemented methods for purposes of describing the various embodiments, but one of ordinary skill in the art can recognize that many further combinations and/or permutations of the various embodiments are possible. Furthermore, to the extent that the terms “includes,” “has,” “possesses,” and the like are used in the detailed description, claims, appendices and/or drawings such terms are intended to be inclusive in a manner similar to the term “comprising” as “comprising” is interpreted when employed as a transitional word in a claim.

The descriptions of the various embodiments have been presented for purposes of illustration but are not intended to be exhaustive or limited to the embodiments described herein. Many modifications and variations will be apparent to those of ordinary skill in the art without departing from the scope and spirit of the described embodiments. The terminology used herein was chosen to best explain the principles of the embodiments, the practical application and/or technical improvement over technologies found in the marketplace, and/or to enable others of ordinary skill in the art to understand the embodiments described herein.

What is claimed is:

1. A system for detecting gas leaks based on sound detection and localization, comprising:
a memory that stores computer executable components;
a processor that executes the computer executable components stored in the memory to perform operations comprising:
receiving sound waves by two or more sound detection devices;
detecting amplitude, phase, and frequency of the respective sound waves at the two or more sound detection devices;
determining phase difference between and frequency spectrum of the respective sound waves; and
as a function of the determined phase difference between and frequency of the respective sound waves, determining a location of a potential gas leak.

2. The system of claim 1, wherein the determining of the location further comprises determining a direction of and a distance to the potential gas leak from at least one of the sound detection devices.

3. The system of claim 2, wherein the direction is determined at least in part based on the determined phase difference.

4. The system of claim 1, wherein the determining of the location is based at least in part on a possible position in common from a range of frequencies.

5. The system of claim 1, further comprising: comparing the detected amplitude and phase of the respective sound waves to measurements of actual gas leaks.

6. The system of claim 1, further comprising training an artificial intelligence model to detect source and character of high-pressure gas leaks from sound leaks received by the two or more sound detection devices.

7. The system of claim 1, further comprising determining direction and distance of the potential gas leak with respect to each sound detection device; and identifying a possible source at least in part by comparing the determined directions and distances.

8. The system of claim 7, wherein the location of the potential gas leak is determined by deriving a single position in common at an intersection of the determined directions and distances of the sound detection devices.

9. The system of claim 1, wherein the sound detection devices are microphones.

10. The system of claim 1, further comprising measuring a sound intensity of the respective sound waves with a sampling rate at least as high as twice a highest detected frequency.

11. A method for detecting gas leaks based on sound detection and localization, comprising:
utilizing a set of at least two sound detection devices located in different locations to receive sound waves;
detecting amplitude, phase, and frequency of the received sound waves;
measuring a phase difference between and a frequency spectrum of the received sound waves; and
utilizing a phase analyzer to determine location of a potential gas leak.

12. The method of claim 11, wherein the phase analyzer further determines respective frequency distributions of detected sound.

13. The method of claim 12, wherein the phase analyzer further compares the determined frequency distributions with predicted or measured frequency spectrums.

14. The method of claim 11, further comprising transmitting a notification regarding location of the potential gas leak.

15. The method of claim 11, further comprising training an artificial intelligence model on signals received from the sound detection devices and the determined location of the potential gas leak.

16. A system for detecting gas leaks based on sound detection and localization, comprising:
a memory that stores computer executable components;
a processor that executes the computer executable components stored in the memory;
a set of at least two disparate sound detection devices that receive sound waves at at least two receiving locations;
a determination component that determines amplitude, phase, and frequency of the respective received sound waves by the set of at least two sound detection devices at the at least two receiving locations;
an analysis component that determines a phase difference between and a frequency spectrum of the respective sound waves received at the at least two locations to determine a location of a potential a gas leak; and
an identification component that identifies location of a potential gas leak.

17. The system of claim 16, further comprising an artificial intelligence component that is trained on signals received by the set of at least two disparate sound detection devices and the identified location of the potential gas leak.

18. The system of claim 16, wherein the location of a potential gas leak is identified at least in part based upon spectral and temporal characteristics of the received sound waves.

19. The system of claim 16, wherein the at least two sound detection devices are microphones.

20. The system of claim 16, wherein the analysis component also determines frequency distribution of detected sounds and compares the frequency distributions with predicted or measured frequency spectrums.
